(19) United States
(12) Patent Application Publication
(10) Pub. No.: US 2025/0254481 A1
(43) Pub. Date: Aug. 7, 2025

(54) HEARING DEVICE, EARPIECE, PROGRAM, AND CONTROL METHOD

(71) Applicant: Sony Group Corporation, Tokyo (JP)

(72) Inventor: Masataka KADO, Tokyo (JP)

(73) Assignee: Sony Group Corporation, Tokyo (JP)

(21) Appl. No.: 18/856,894

(22) PCT Filed: Apr. 18, 2023
(86) PCT No.: PCT/JP2023/015526

§ 371 Date: Oct. 15, 2024

(30) Foreign Application Priority Data
Apr. 25, 2022 (JP) 2022-071309

(51) Int. Cl. H04R 25/00; H04R 1/10

(52) U.S. Cl. CPC H04R 25/656; H04R 1/1016; H04R 1/1041; H04R 25/505; H04R 2225/61; H04R 2460/09; H04R 2460/11

(57) ABSTRACT

A hearing device according to an aspect of the present disclosure includes a main body unit and an earpiece insertable into an external ear canal of a user. The main body unit or the earpiece includes a ventilation adjustment mechanism including a soft actuator at least in a part thereof and capable of adjusting a ventilation amount between the external ear canal and outside air. The main body unit includes a microphone that collects external sound and generates an external sound signal, a signal processing unit that amplifies the external sound signal, a receiver that outputs sound corresponding to the external sound signal amplified by the signal processing unit, and a control unit that changes a shape of the soft actuator.

### FIELD

The present disclosure relates to a hearing device, an earpiece, a program, and a control method.

### BACKGROUND

In an ear mold used for a hearing aid or the like, there has been known a technique of providing a vent channel having a vent opening for ventilating an external ear canal of a user wearing the ear mold, enabling pressure equalization between the external ear canal and the periphery, and reducing or avoiding a blocking effect (see, for example, Patent Literature 1). In this technique, a magnetic member including a closing element switchable to a first state or a second state is provided in an auditory device main body and a first vent port provided in a vent channel is opened in the first state and the first vent port is closed in the second state to reduce or avoid the blocking effect.

### CITATION LIST

### Patent Literature

Patent Literature 1: JP 2020-108141 A

### SUMMARY

### Technical Problem

However, in Patent Document 1 described above, since the magnetic member is a mechanism using a magnetic force, there is a problem in that a motion sound is generated in the ear of the user at the time of transition from the first state to the second state or from the second state to the first state to give discomfort to the user.

The present disclosure has been made in view of the above, and an object of the present disclosure is to provide a hearing device, an earpiece, a program, and a control method that can be comfortably used by a user.

### Solution to Problem

In order to solve the above problem and achieve the objective, a hearing device according to an aspect of the present disclosure includes: a main body unit; and an earpiece insertable into an external ear canal of a user, wherein the main body unit or the earpiece includes a ventilation adjustment mechanism including a soft actuator at least in a part thereof and capable of adjusting a ventilation amount between the external ear canal and outside air, and the main body unit includes: a microphone that collects external sound and generates an external sound signal; a signal processing unit that amplifies the external sound signal; a receiver that outputs sound corresponding to the external sound signal amplified by the signal processing unit; and a control unit that changes a shape of the soft actuator.

An earpiece according to an aspect of the present disclosure attachable to a main body unit including a microphone that collects external sound to generate an external sound signal, a signal processing unit that amplifies the external sound signal, a receiver that outputs sound corresponding to the external sound signal amplified by the signal processing unit, and a control unit, the earpiece being insertable into an external ear canal of a user, the earpiece comprising a ventilation adjustment mechanism including a soft actuator in at least a part thereof and capable of adjusting a ventilation amount between the external ear canal and outside air under control of the control unit.

A program according to an aspect of the present disclosure to be executed by a hearing device including a main body unit including a microphone that collects external sound to generate an external sound signal, a signal processing unit that amplifies the external sound signal, a receiver that outputs sound corresponding to the external sound signal amplified by the signal processing unit, and a control unit and an earpiece insertable into an external ear canal of a user, the main body unit or the earpiece including a ventilation adjustment mechanism including a soft actuator in at least a part thereof and capable of adjusting a ventilation amount between the external ear canal and outside air, the program causing the control unit to change a shape of the soft actuator.

A control method according to an aspect of the present disclosure to be executed by a hearing device including a main body unit including a microphone that collects external sound to generate an external sound signal, a signal processing unit that amplifies the external sound signal, a receiver that outputs sound corresponding to the external sound signal amplified by the signal processing unit, and a control unit and an earpiece insertable into an external ear canal of a user, the main body unit or the earpiece including a ventilation adjustment mechanism including a soft actuator in at least a part thereof and capable of adjusting a ventilation amount between the external ear canal and outside air, the control method comprising by the control unit, executing changing a shape of the soft actuator.

### BRIEF DESCRIPTION OF THE DRAWINGS

FIG. 1 is a diagram illustrating a schematic configuration of a hearing aid system according to an embodiment.

FIG. 2 is a block diagram illustrating a functional configuration of a hearing aid according to the embodiment.

FIG. 3 is a diagram illustrating a schematic configuration of an earpiece according to the embodiment.

FIG. 4 is a diagram schematically illustrating a ventilation passage in an opened state by a soft actuator according to the embodiment.

FIG. 5 is a diagram schematically illustrating the ventilation passage in a closed state by the soft actuator according to the embodiment.

FIG. 6 is a flowchart illustrating an overview of processing executed by the hearing aid according to the embodiment.

FIG. 7 is a schematic diagram of an opened state in a ventilation adjustment mechanism according to a modification 1 of the embodiment.

FIG. 8 is a schematic diagram illustrating a cross section of the opened state in a ventilation adjustment mechanism according to the modification 1 of the embodiment.

FIG. 9 is a schematic diagram of a closed state in the ventilation adjustment mechanism according to the modification 1 of the embodiment.

FIG. 10 is a schematic diagram illustrating a cross section of the closed state in the ventilation adjustment mechanism according to the modification 1 of the embodiment.

FIG. 11 is a schematic diagram of an opened state in a ventilation adjustment mechanism according to a modification 2 of the embodiment.

FIG. 12 is a schematic diagram illustrating a cross section of the opened state in the ventilation adjustment mechanism according to the modification 2 of the embodiment.

FIG. 13 is a schematic diagram of a closed state in the ventilation adjustment mechanism according to the modification 2 of the embodiment.

FIG. 14 is a schematic diagram illustrating a cross section of the closed state in the ventilation adjustment mechanism according to the modification 2 of the embodiment.

FIG. 15 is a diagram illustrating a schematic configuration of an opened state of a hearing aid system according to a modification 3 of the embodiment.

FIG. 16 is a diagram illustrating a schematic configuration of a closed state of the hearing aid system according to the modification 3 of the embodiment.

FIG. 17 is a diagram illustrating a schematic configuration of a hearing aid according to another embodiment.

FIG. 18 is a block diagram illustrating a functional configuration of a hearing aid according to the other embodiment.

FIG. 19 is a diagram illustrating a schematic configuration of a ventilation adjustment mechanism according to the other embodiment.

FIG. 20 is a flowchart illustrating an overview of processing executed by the hearing aid according to the other embodiment.

FIG. 21 is a diagram illustrating a schematic configuration of a ventilation adjustment mechanism according to a modification 1 of the other embodiment.

FIG. 22 is a diagram illustrating a schematic configuration of a ventilation adjustment mechanism according to a modification 2 of the other embodiment.

FIG. 23 is a diagram illustrating a schematic configuration of a ventilation adjustment mechanism according to a modification 3 of the other embodiment.

### DESCRIPTION OF EMBODIMENTS

Modes for carrying out the present disclosure are explained in detail below with reference to the drawings. Note that the present disclosure is not limited by embodiments explained below. The drawings referred to in the following explanation merely schematically illustrates shapes, sizes, and positional relations to an extent that the content of the present disclosure can be understood. That is, the present disclosure is not limited to only the shapes, the sizes, and the positional relations illustrated in the drawings. Further, in the description of the drawings, the same portions are denoted by the same reference numerals and signs. Furthermore, as a hearing system according to the present disclosure, a hearing aid system using a hearing aid is explained as an example and, as an example of this hearing aid system, a hearing aid system including a set of left and right ear hole type hearing aids is explained.

### 1. Embodiment

### <Overview of a Hearing Aid System>

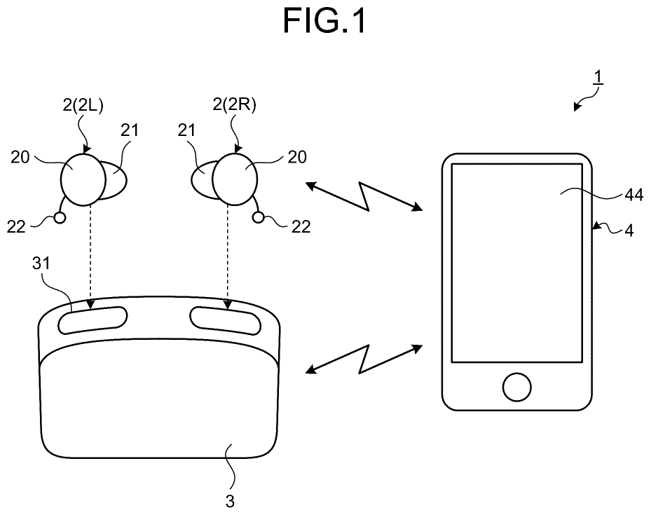

FIG. 1 is a diagram illustrating a schematic configuration of a hearing aid system according to an embodiment.

A hearing aid system 1 illustrated in FIG. 1 includes a set of left and right hearing aids 2, a charging device 3 (a charging case) that houses the hearing aids 2 in housing sections 31 and charges the hearing aids 2, and a communication device 4 such as a mobile phone capable of communicating with at least one of the hearing aids 2 and the charging device 3.

In the embodiment, the hearing aid 2 of an air conduction type is explained as a hearing device. However, not only this, but, for example, a bone conduction type can also be applied. Further, in the embodiment, a case in which the hearing aid 2 is an ear hole type is explained. However, not only this, but, for example, an ear hook type, a headphone type, and a pocket type can also be applied. Furthermore, in the embodiment, a case in which the hearing aid 2 is a binaural type is explained. However, not only this, but, a single ear type to be worn on one of the left and right can also be applied. In the following explanation, the hearing aid 2 worn on the right ear is described as hearing aid 2R, the hearing aid 2 worn on the left ear is described as hearing aid 2L, and, when the hearing aid 2 indicates one of the left and the right, the hearing aid 2 is simply referred to as hearing aid 2. In the embodiment, an example in which the hearing aid 2 is used as the hearing device is explained. However, not only this, but, for example, a wired or wireless earphone can also be applied.

### <Configuration of the Hearing Aid>

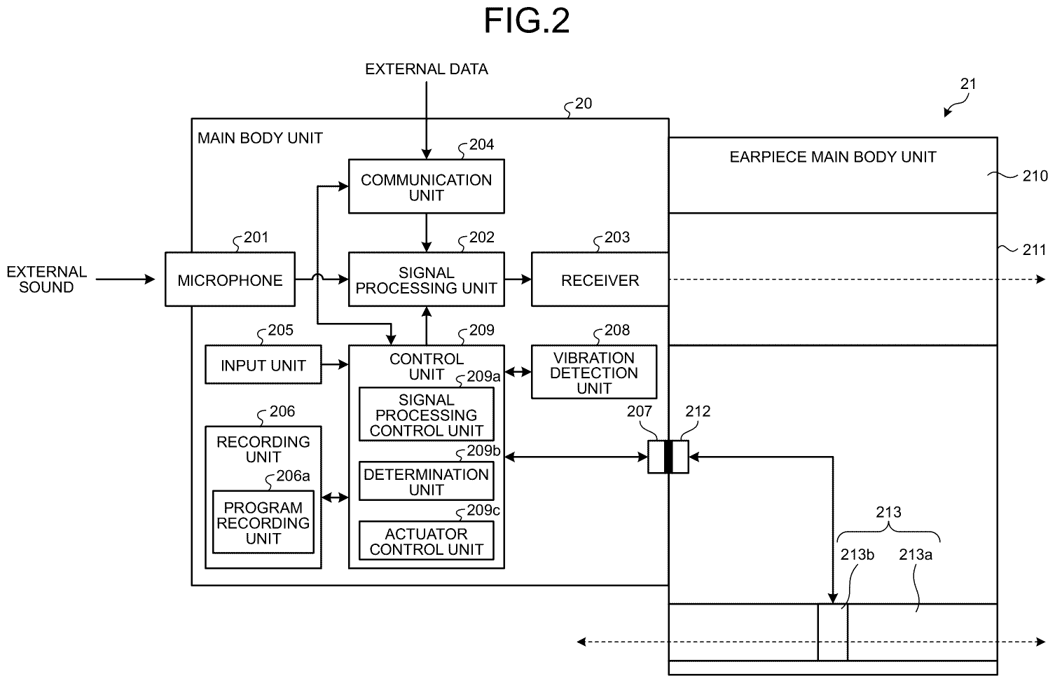

Subsequently, a detailed functional configuration of the hearing aid 2 according to the embodiment is explained. FIG. 2 is a block diagram illustrating a functional configuration of the hearing aid 2 according to the embodiment.

As illustrated in FIG. 1 and FIG. 2, the hearing aid 2 includes a main body unit 20 having a shape insertable into an ear hole of the user, an earpiece 21 that is detachably attachable to the main body unit 20 and is inserted into the ear hole of the user via the main body unit 20, and a taking-out thread 22 for taking out the hearing aid 2 from the ear hole of the user.

As illustrated in FIG. 2, the main body unit 20 includes a microphone 201, a signal processing unit 202, a receiver 203, a communication unit 204, an input unit 205, a recording unit 206, a connection unit 207, a vibration detection unit 208, and a control unit 209.

The microphone 201 collects external sound to generate an analog external sound signal (an acoustic signal) and outputs the external sound signal to the signal processing unit 202.

Under the control of the control unit 209, the signal processing unit 202 performs A/D conversion processing, predetermined signal processing, and D/A conversion processing on the external sound signal input from the microphone 201 and outputs the external sound signal to the receiver 203. Specifically, first, the signal processing unit 202 performs, on the analog external sound signal, A/D conversion processing of converting the analog external sound signal into a digital external sound signal. Subsequently, the signal processing unit 202 performs, on the digital external sound signal, filtering processing of separating the external sound signal for each predetermined frequency, amplification processing for amplifying, with a predetermined amplification amount, the external sound signal for each predetermined frequency subjected to the filtering processing, noise reduction processing for removing noise, howling cancellation processing, and the like. Finally, the signal processing unit 202 performs D/A conversion processing on the digital external sound signal subjected to the predetermined signal processing, converts the digital external sound signal into an analog external sound signal, and outputs the analog external sound signal to the receiver 203. The signal processing unit 202 performs predetermined signal processing on a sound signal of external data input from the communication unit 204 and outputs the sound signal to the receiver 203. The signal processing unit 202 is configured using a memory and a processor including hardware such as a DSP (Digital Signal Processor).

The receiver 203 outputs output sound corresponding to the analog external sound signal or the sound signal of the external data input from the signal processing unit 202. The receiver 203 is configured using, for example, a speaker.

Under the control of the control unit 209, the communication unit 204 bidirectionally communicates with the communication device 4 and external equipment such as a television according to a predetermined communication standard via a not-illustrated network and receives external data and the like. Here, as the predetermined communication standard, for example, Wi-Fi (registered trademark), Bluetooth (registered trademark), and the like are assumed. The external data includes a digital sound signal and identification information for identifying external equipment. The communication unit 204 is configured using a communication module or the like including an antenna and a reception circuit.

The input unit 205 receives various kinds of operation by the user and outputs information corresponding to the received operation to the control unit 209. The input unit 205 includes buttons and switches.

The recording unit 206 records various kinds of information concerning the hearing aid 2. The recording unit 206 is configured using a RAM (Random Access Memory), a ROM (Read Only Memory), a memory card, and the like. The recording unit 206 includes a program recording unit 206a that records a program to be executed by the hearing aid 2 and various data being processed by the hearing aid 2.

When the earpiece 21 is attached to the main body unit 20, the connection unit 207 is electrically connected to a connection unit of the earpiece 21 explained below and outputs various control signals input from the control unit 209 to a soft actuator of the earpiece 21. The connection unit 207 is configured using a plurality of pins, a signal line, and the like.

The vibration detection unit 208 detects vibration occurring in the main body unit 20 and outputs the detection to the control unit 209 as a vibration signal. The vibration detection unit 208 is configured using, for example, a gyro sensor or an acceleration sensor. Note that the vibration detection unit 208 may detect a movement of a chin at the time when the user utters and output this movement to the control unit 209 as a movement signal.

The control unit 209 controls the units configuring the hearing aid 2. The control unit 209 is configured using a memory and a processor having hardware such as a CPU (Central Processing Unit) or a DSP. The control unit 209 reads the program recorded in the program recording unit 206a to work area of the memory and executes the program and controls the components and the like through the execution of the program by the processor, whereby hardware and software cooperate to implement a functional module matching a predetermined purpose. Specifically, the control unit 209 includes a signal processing control unit 209a, a determination unit 209b, and an actuator control unit 209c.

The signal processing control unit 209a controls the signal processing unit 202 such that the signal processing unit 202 amplifies an external sound signal input from the microphone 201 or a sound signal input from the communication unit 204 at a predetermined amplification factor.

The determination unit 209b determines whether the communication unit 204 has received a sound signal from external equipment, for example, the communication device 4. The determination unit 209b determines whether a state of a ventilation passage 213a is an opened state. The determination unit 209b determines whether the user has uttered.

The actuator control unit 209c changes the shape of a soft actuator included in a ventilation adjustment mechanism of the earpiece 21 explained below. Specifically, the actuator control unit 209c changes the shape of the soft actuator explained below based on a reception state of a sound signal included in external data from the external communication device 4 by the communication unit 204.

### <Configuration of the Earpiece>

Subsequently, a configuration of the earpiece 21 according to the embodiment is explained.

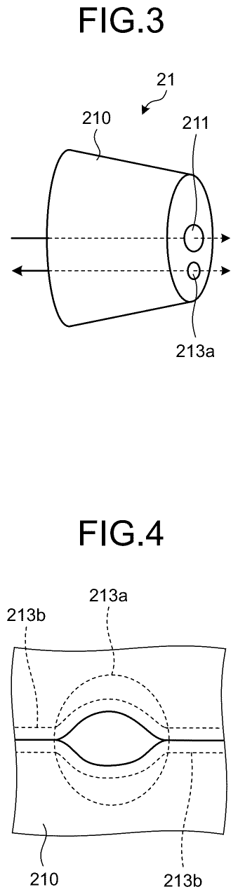

FIG. 3 is a diagram illustrating a schematic configuration of the earpiece 21 according to the embodiment.

The earpiece 21 illustrated in FIG. 2 and FIG. 3 includes an earpiece main body unit 210, a hole 211, a connection unit 212, and a ventilation adjustment mechanism 213.

The earpiece main body unit 210 is formed in a substantially truncated cone shape and is detachably attached to the main body unit 20. The earpiece main body unit 210 is formed using, for example, silicon having two types of hardness. For example, the earpiece main body unit 210 retains the shape of the hole 211 formed as a sound passage by using silicon of a hard material as a core portion and prevents sound quality deterioration due to crushing of a distal end due to an external force. In addition, in the earpiece main body unit 210, silicon of a soft material is used for an outer portion inserted into the ear hole of the user to increase confidentiality and implement comfortable wearing even for a long time while improving a wearing feeling on the ear of the user.

The hole 211 is provided in the earpiece main body unit 210. The hole 211 forms a passage for sound output from the receiver 203.

When the earpiece 21 is attached to the main body unit 20, the connection unit 212 is electrically connected to the connection unit of the earpiece 21 explained below and outputs various control signals and electric power input from the control unit 209 to the ventilation adjustment mechanism 213. The connection unit 207 is configured using a plurality of pins, a signal line, and the like.

The ventilation adjustment mechanism 213 adjusts a ventilation amount between the external ear canal of the user and the outside when the hearing aid 2 is worn on the ear of the user. The ventilation adjustment mechanism 213 includes the ventilation passage 213a functioning as a vent for ventilating the external ear canal of the user and the outside when the hearing aid 2 is worn on the ear of the user and a soft actuator 213b that adjusts a ventilation amount of the ventilation passage 213a.

The soft actuator 213b is provided in the ventilation passage 213a and adjusts the ventilation amount of the ventilation passage 213a by switching a state of the ventilation passage 213a between an opened state and a closed state under the control of the actuator control unit 209c based on a control signal (electricity) input via the connection unit 212. Here, the soft actuator 213b is configured using a conductive polymer actuator capable of expanding and contracting according to a voltage or an electric current. For example, the conductive polymer actuator is configured using polyaniline, polypyrrole, or the like. In this case, the soft actuator 213b contracts (shrinks) when electric power (a positive voltage) is supplied from the control unit 209 and expands (enlarges) when the electric power is stopped.

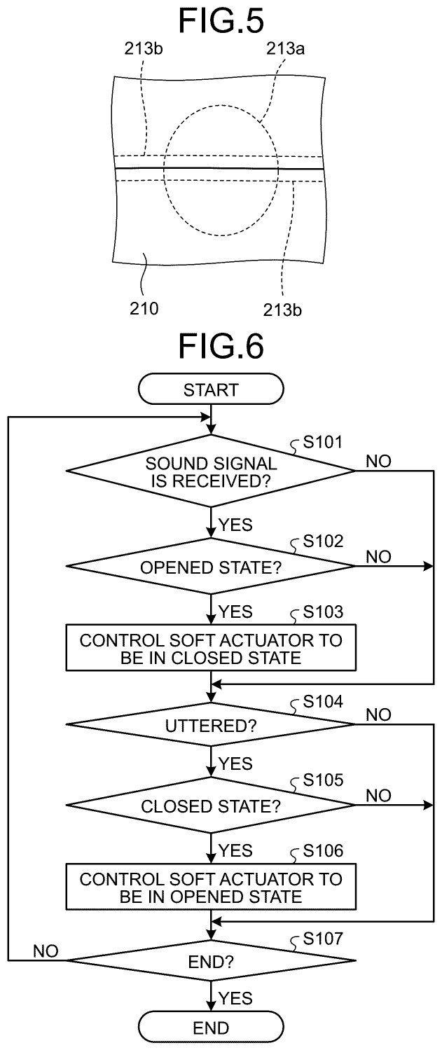

FIG. 4 is a diagram schematically illustrating the ventilation passage 213a in the opened state by the soft actuator 213b. FIG. 5 is a diagram schematically illustrating the ventilation passage 213a in the closed state by the soft actuator 213b.

As illustrated in FIG. 4 and FIG. 5, the soft actuator 213b is provided at both ends, for example, above and below or on the left and the right of the ventilation passage 213a. The soft actuator 213b changes its shape by expanding and contracting under the control of the actuator control unit 209c based on a control signal (electricity) input via the connection unit 212. Specifically, the soft actuator 213b adjusts the ventilation amount of the ventilation passage 213a by changing the shape to an expanded state or a contracted state and switching the state of the ventilation passage 213a between the opened state (see FIG. 4) and the closed state (see FIG. 5) under the control of the actuator control unit 209c.

As explained above, the ventilation adjustment mechanism 213 can adjust a ventilation amount between the external ear canal of the user and the outside under the control of the actuator control unit 209c when the hearing aid 2 is worn on the ear of the user.

In FIG. 4 and FIG. 5, the soft actuator 213b is provided only in one part in the ventilation passage 213a. However, not only this, but a plurality of soft actuators 213b may be provided in the ventilation passage 213a. The soft actuator 213b is provided in the ventilation passage 213a. However, not only this, but the soft actuator 213b may be provided, for example, at one of both the ends of the ventilation passage 213a and can be changed as appropriate.

### <Processing of the Hearing Aid>

Subsequently, processing executed by the hearing aid 2 according to the embodiment is explained.

FIG. 6 is a flowchart illustrating an overview of processing executed by the hearing aid 2 according to the embodiment.

As illustrated in FIG. 6, first, the determination unit 209b determines whether the communication unit 204 has received a sound signal from external equipment, for example, the communication device 4 (step S101). When the determination unit 209b determines that the communication unit 204 has received a sound signal from the external equipment (step S101: Yes), the hearing aid 2 shifts to step S102 explained below. In contrast, when the determination unit 209b determines that the communication unit 204 has not received a sound signal from the external equipment (step S101: No), the hearing aid 2 shifts to step S104 explained below.

In step S102, the determination unit 209b determines whether the state of the ventilation passage 213a is the opened state. Specifically, the determination unit 209b determines whether the actuator control unit 209c has stopped the supply of electric power to the soft actuator 213b, determines that the state of the ventilation passage 213a is the opened state when determining that the actuator control unit 209c has stopped the supply of electric power to the soft actuator 213b, and determines that the state of the ventilation passage 213a is the closed state when determining that the actuator control unit 209c is supplying electric power to the soft actuator 213b. When the determination unit 209b determines that the state of the ventilation passage 213a is the opened state (step S102: Yes), the hearing aid 2 shifts to step S103 explained below. In contrast, when the determination unit 209b determines that the state of the ventilation passage 213a is not the opened state (step S102: No), the hearing aid 2 shifts to step S104 explained below.

In step S103, the actuator control unit 209c controls the soft actuator 213b to change the opened state of the ventilation passage 213a to the closed state. Specifically, the actuator control unit 209c drives the soft actuator 213b disposed on both the sides of the ventilation passage 213a by supplying electric power to the soft actuator 213b and switches the state of the ventilation passage 213a from the opened state to the closed state by deforming the shape of the soft actuator 213b from the expanded state to the contracted state (see FIG. 4→FIG. 5). Accordingly, the user wearing the hearing aid 2 can listen to sound (for example, music) corresponding to a sound signal transmitted from the communication device 4 with a sufficient sound pressure at the time of music play without worrying about external sound. In this case, the signal processing control unit 209a may control an amplification factor by the signal processing unit 202 for the sound signal received by the communication unit 204. For example, the signal processing control unit 209a may set an amplification factor of a sound signal input from the communication unit 204 to be higher than an amplification factor of a sound signal input from the microphone 201. After step S103, the hearing aid 2 shifts to step S104 explained below.

Thereafter, the determination unit 209b determines whether at least one of the user and another person located near the user (hereinafter, simply referred to as “the other person”) has uttered (step S104). Specifically, the determination unit 209b determines whether a sound signal corresponding to at least one of utterance uttered by the user wearing the hearing aid 2 and utterance of the other person has been input from the microphone 201. For example, the determination unit 209b determines whether the volume of the sound signal (the magnitude of the sound signal) corresponding to at least one of the utterance uttered by the user and the utterance of the other person is equal to or greater than a predetermined threshold. Naturally, the determination unit 209b may determine, based on a degree of coincidence between a waveform of the sound signal and a waveform of voice at the time when the user has uttered registered in advance, whether the user has uttered. Further, the determination unit 209b may determine, based on a vibration signal detected by the vibration detection unit 208, whether the user has uttered. When the determination unit 209b determines that at least one of the user and the other person has uttered (step S104: Yes), the hearing aid 2 shifts to step S105 explained below. In contrast, when the determination unit 209b determines that at least one of the user and the other person has not uttered (step S104: No), the hearing aid 2 shifts to step S107 explained below.

In step S105, the determination unit 209b determines whether the state of the ventilation passage 213a is the closed state. Specifically, the determination unit 209b determines whether the actuator control unit 209c is supplying electric power to the soft actuator 213b and, when determining that the actuator control unit 209c is supplying electric power to the soft actuator 213b, determines that the state of the ventilation passage 213a is the closed state and, determining that the actuator control unit 209c has stopped the supply of electric power to the soft actuator 213b, determines that the state of the ventilation passage 213a is the opened state. When the determination unit 209b determines that the state of the ventilation passage 213a is the closed state (step S105: Yes), the hearing aid 2 shifts to step S106 explained below. In contrast, when the determination unit 209b determines that the state of the ventilation passage 213a is not the closed state (step S105: No), the hearing aid 2 shifts to step S107 explained below.

In step S106, the actuator control unit 209c controls the soft actuator 213b to change the state of the ventilation passage 213a to the opened state. Specifically, the actuator control unit 209c stops driving of the soft actuator 213b disposed on both the sides of the ventilation passage 213a by stopping electric power to the soft actuator 213b and switches the state of the ventilation passage 213a from the closed state to the opened state by deforming the shape of the soft actuator 213b from the contracted state to the expanded state (see FIG. 5→FIG. 4). As a result, since the ventilation passage 213a of the ventilation adjustment mechanism 213 is in the opened state, the user wearing the hearing aid 2 can prevent howling. Therefore, the user can listen to external sound such as utterance of the user or the other person. After step S106, the hearing aid 2 shifts to step S107 explained below.

In step S107, the determination unit 209b determines whether the user has finished wearing the hearing aid 2. For example, the determination unit 209b determines whether the user has performed operation of turning off the hearing aid 2 via the input unit 205 and, when the user has performed the operation of turning off the hearing aid 2 via the input unit 205, determines that the user has finished wearing the hearing aid 2 and, when the user has not performed the operation of turning off the hearing aid 2 via the input unit 205, determines that the user has not finished wearing the hearing aid 2. When the determination unit 209b determines that the user has finished wearing the hearing aid 2 (step S107: Yes), the hearing aid 2 ends this processing. On the other hand, when the determination unit 209b determines that the user has not finished wearing the hearing aid 2 (step S107: No), the hearing aid 2 returns to step S101 explained above.

According to the embodiment explained above, since the actuator control unit 209c controls the shape of the soft actuator 213b, the user can comfortably use the hearing aid 2.

According to the embodiment, since the actuator control unit 209c changes the shape of the soft actuator 213b based on the reception state of the communication unit 204, the ventilation amount of the ventilation adjustment mechanism 213 can be adjusted in a state suitable for each of the sound signal of the external data transmitted from the communication device 4 and the external sound signal input from the microphone 201.

According to the embodiment, when receiving the sound signal transmitted from the communication device 4 with the communication unit 204, the actuator control unit 209c changes the shape of the soft actuator 213b such that the ventilation amount of the ventilation adjustment mechanism 213 decreases and, when receiving the input of the external sound signal from the microphone 201, the actuator control unit 209c changes the shape of the soft actuator 213b such that the ventilation amount of the ventilation adjustment mechanism 213 increases. Therefore, the user can comfortably use the hearing aid 2 in a state suitable for each of a music playing function and a hearing aid function.

According to the embodiment, when the determination unit 209b determines that the user has uttered, the actuator control unit 209c changes the shape of the soft actuator 213b from the closed state to the opened state. Therefore, the user can switch the performance of the hearing aid 2 to performance suitable for listening to utterance of the user and utterance of the other person in conversation or the like.

In the embodiment, when receiving input of an instruction signal for instructing to change the shape of the soft actuator 213b from the input unit 205, the actuator control unit 209c may change the shape of the soft actuator 213b to a shape corresponding to the instruction signal to adjust the ventilation amount of the ventilation adjustment mechanism 213. For example, when the shape of the soft actuator 213b is in the closed state, the actuator control unit 209c may change the shape of the soft actuator 213b from the closed state to the opened state when an instruction signal for instructing the soft actuator 213b to the opened state is input from the input unit 205. Accordingly, even when the user is listening to music play, the user can manually switch the performance of the hearing aid 2 to performance suitable for external sound.

In the embodiment, the determination unit 209b determines, based on the external sound signal input from the microphone 201, whether the user has uttered. However, not only this, but the determination unit 209b may determine, based on a vibration signal detected by the vibration detection unit 208, whether the user has uttered. For example, the determination unit 209b may determine whether a cycle of the vibration signal detected by the vibration detection unit 208 coincides with a movement of the chin of the user and, when the cycle of the vibration signal coincides with the movement of the chin, determine that the user is uttering. Naturally, the determination unit 209b may determine, based on the vibration signal detected by the vibration detection unit 208, whether the user directs the face or the ears to a sound source and, when determining that the user directs the face or the ears to the sound source, output an instruction signal to the actuator control unit 209c to change the state of the soft actuator 213b to the opened state. Further, the determination unit 209b may determine, based on the vibration signal detected by the vibration detection unit 208, whether the user is performing a specific motion (for example, a motion of shaking the head to the left and the right or up and down or a blinking motion) and, when determining that the user is performing the specific motion, output an instruction signal to the actuator control unit 209c to change the shape of the soft actuator 213b to the opened state.

In the embodiment, the actuator control unit 209c changes the shape of the soft actuator 213b to one of the opened state and the closed state. However, not only this, but the actuator control unit 209c may adjust the ventilation amount by adjusting the size (an opening amount) of the opening of the ventilation passage 213a by adjusting an amount of electric power supplied (applied) to the soft actuator 213b. Naturally, the actuator control unit 209c adjusts the amount of electric power supplied to the soft actuator 213b according to an instruction signal, input from the input unit 205, for instructing the size of the opening of the ventilation passage 213a. Accordingly, the user can comfortably use the hearing aid 2 in a state corresponding to preference of the user. Naturally, the actuator control unit 209c may supply, to the soft actuator 213b, an amount of electric power for obtaining a ventilation amount set in advance by the user with fitting or the like.

### (Modification 1)

Subsequently, a modification 1 of the embodiment of the present disclosure is explained. In the modification 1, only a configuration of a soft actuator included in a ventilation adjustment mechanism is different. For this reason, in the following explanation, a soft actuator 302 of a ventilation adjustment mechanism 300 according to the modification 1 is explained. Note that the same components as the components of the hearing aid system 1 according to the embodiment explained above are basically denoted by the same reference numerals and signs, and detailed explanation of the components is omitted.

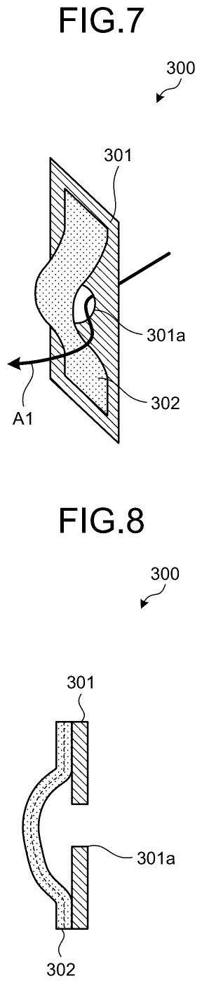

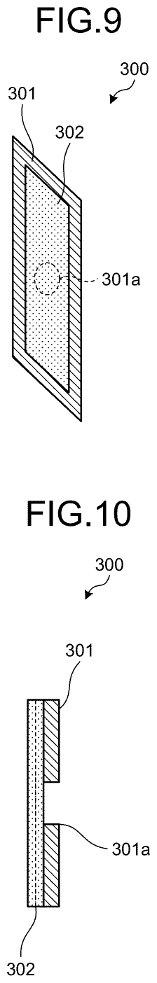

FIG. 7 is a schematic diagram of an opened state in the ventilation adjustment mechanism 300 according to the modification 1 of the embodiment. FIG. 8 is a schematic diagram illustrating a cross section the opened state in the ventilation adjustment mechanism 300 according to the modification 1 of the embodiment. FIG. 9 is a schematic diagram of a closed state of the ventilation adjustment mechanism 300 according to the modification 1 of the embodiment. FIG. 10 is a schematic diagram illustrating a cross section of the closed state in the ventilation adjustment mechanism 300 according to the modification 1 of the embodiment.

As illustrated in FIG. 7 to FIG. 10, the ventilation adjustment mechanism 300 includes a plate section 301 and a soft actuator 302 instead of the soft actuator 213b of the ventilation adjustment mechanism 213 according to the embodiment explained above.

The plate section 301 is provided in the ventilation passage 213a of the earpiece 21 explained above and has an opening 301a through which ventilation is possible.

The soft actuator 302 is provided in close contact with the plate section 301 and is provided in the ventilation passage 213a of the earpiece 21. The soft actuator 302 is configured using a conductive polymer actuator. The soft actuator 302 is formed in a plate shape to close the opening 301a of the plate section 301 functioning as a vent.

The soft actuator 302 configured as explained above adjusts a ventilation amount of air A1 (see FIG. 7) passing through the ventilation passage 213a by switching the state of the ventilation passage 213a between the opened state (see FIG. 7 and FIG. 8) and the closed state (see FIG. 9 and FIG. 10) under the control of the actuator control unit 209c.

According to the modification 1 explained above, the user can comfortably use the hearing aid 2 as in the embodiment explained above.

### (Modification 2)

Subsequently, a modification 2 of the embodiment of the present disclosure is explained. In the modification 2, only a configuration of a soft actuator included in a ventilation adjustment mechanism is different. For this reason, a soft actuator 312 of a ventilation adjustment mechanism 310 according to the modification 2 is explained below. Note that the same components as the components of the hearing aid system 1 according to the embodiment explained above are basically denoted by the same reference numerals and signs, and detailed explanation of the components is omitted.

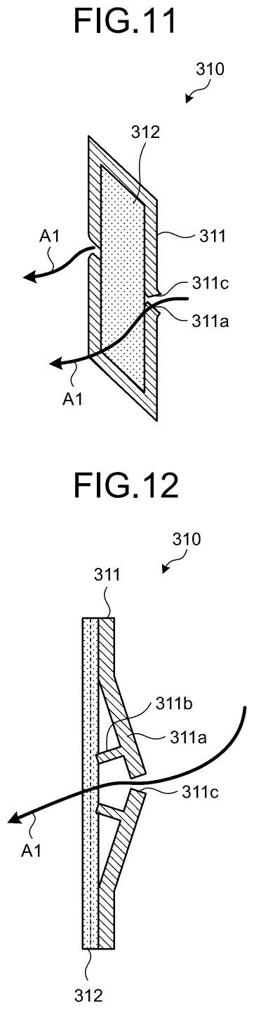

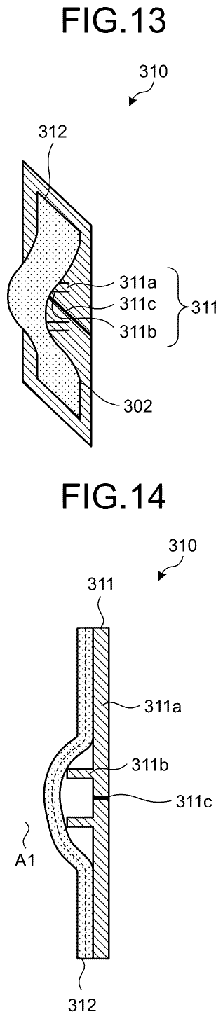

FIG. 11 is a schematic diagram of an opened state of the ventilation adjustment mechanism 310 according to the modification 2 of the embodiment. FIG. 12 is a schematic diagram illustrating a cross section of the opened state in the ventilation adjustment mechanism 310 according to the modification 2 of the embodiment. FIG. 13 is a schematic diagram of a closed state of the ventilation adjustment mechanism 310 according to the modification 2 of the embodiment. FIG. 14 is a schematic diagram illustrating a cross section of the closed state in the ventilation adjustment mechanism 310 according to the modification 2 of the embodiment.

The ventilation adjustment mechanism 310 illustrated in FIG. 11 to FIG. 14 includes a plate section 311 and a soft actuator 312 instead of the ventilation passage 213a and the soft actuator 213b of the ventilation adjustment mechanism 213 according to the embodiment explained above.

The plate section 311 is provided in the ventilation passage 213a of the earpiece 21 explained above. The plate section 311 is configured using an elastic member or the like and includes a deformable elastic section 311a, a protrusion 311b that presses the soft actuator 312 in a predetermined direction, and an opening 311c formed by the elastic section 311a deforming when being pressed by the soft actuator 312.

The soft actuator 312 is provided in a state of being pressed by the protrusion 311b of the plate section 311 and is provided in the ventilation passage 213a of the earpiece 21. The soft actuator 312 is configured using a conductive polymer actuator. The soft actuator 312 has a plate shape to close the opening 311c of the plate section 311 functioning as a vent.

The soft actuator 312 configured as explained above presses the protrusion 311b in a direction opposite to a pressing direction of the protrusion 311b of the plate section 311 by changing from an expanded state to a contracted state under the control of the actuator control unit 209c when electric power is supplied. Accordingly, in the plate section 311, the elastic section 311a is deformed by the protrusion 311b being pressed by the soft actuator 312, whereby the opening 311c is formed. As a result, the soft actuator 312 can adjust a ventilation amount of the air A1 (see FIG. 11 and FIG. 12) passing through the ventilation passage 213a by switching a state of the ventilation passage 213a between the opened state (see FIG. 11 and FIG. 12) and the closed state (see FIG. 13 and FIG. 14). In this case, the actuator control unit 209c may adjust an opening amount of the opening 311c by adjusting electric power supplied to the soft actuator 312.

According to the modification 2 of the embodiment explained above, the user can comfortably use the hearing aid 2 as in the embodiment explained above.

### (Modification 3)

Subsequently, a modification 3 of the embodiment of the present disclosure is explained. In the modification 3, only a configuration of a soft actuator included in a ventilation adjustment mechanism is different. For this reason, a soft actuator 320 of a ventilation adjustment mechanism according to the modification 2 is explained below. Note that the same components as the components of the hearing aid system 1 according to the embodiment explained above are basically denoted by the same reference numerals and signs, and detailed explanation of the components is omitted.

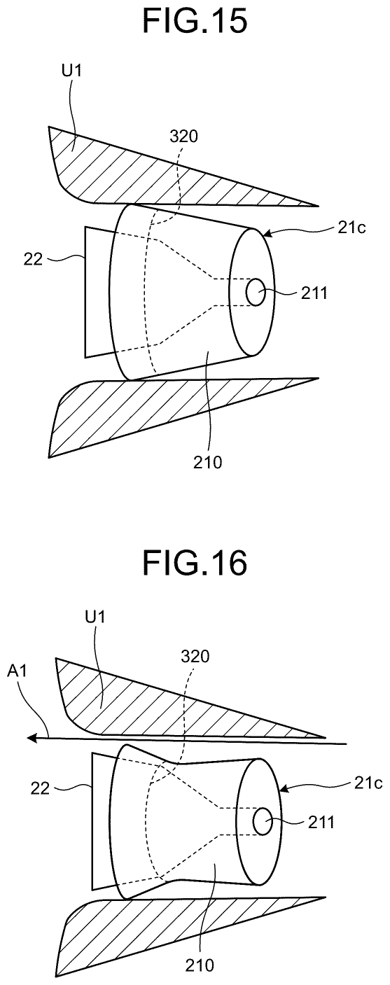

FIG. 15 is a diagram illustrating a schematic configuration of an opened state of a hearing aid system according to the modification 3 of the embodiment. FIG. 16 is a diagram illustrating a schematic configuration of a closed state of the hearing aid system according to the modification 3 of the embodiment.

The hearing aid system illustrated in FIG. 15 and FIG. 16 includes an earpiece 21c instead of the earpiece 21 according to the embodiment explained above. The earpiece 21c includes a soft actuator 320 instead of the soft actuator 213b according to the embodiment explained above.

The soft actuator 320 is provided in an annular shape along the shape of the earpiece main body unit 210. The soft actuator 320 is provided in any one or more of the inside, a surface layer, and an inner layer of the earpiece main body unit 210. The soft actuator 320 is configured using a conductive polymer actuator. Under the control of the actuator control unit 209c, the soft actuator 320 transitions from an expanded state to a contracted state by being applied with a voltage. That is, under the control of the actuator control unit 209c, when a voltage is applied, the soft actuator 320 decreases in the inner diameter and changes the outer shape of the earpiece main body unit 210 (see FIG. 15→FIG. 16). Accordingly, in the hearing aid system 1, a gap is formed between the earpiece 21c and the external ear canal of a user U1. This gap functions as a vent capable of ventilating the external ear canal and the outside air.

According to the modification 3 of the embodiment explained above, as in the embodiment explained above, the user can comfortably use the hearing aid 2.

### 2. Another Embodiment

### <Configuration of the Hearing Aid>

Subsequently, a detailed functional configuration of the hearing aid 2 according to another embodiment is explained. In another embodiment, only a configuration of a set of left and right hearing aids 2 is different. For this reason, the hearing aid 2 according to the other embodiment is explained below. Note that the same components as the components of the hearing aid system 1 according to the embodiment explained above are basically denoted by the same reference numerals and signs, and detailed explanation of the components is omitted.

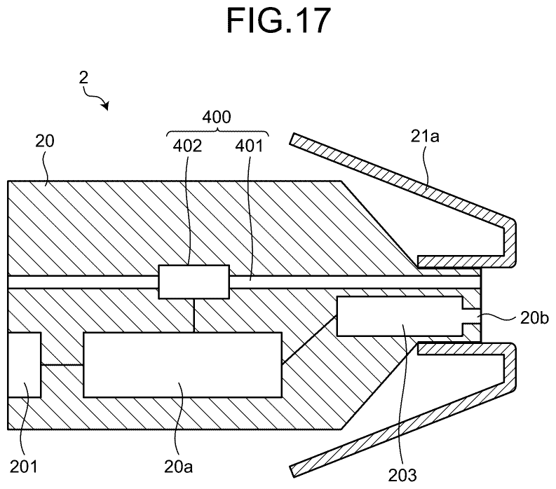

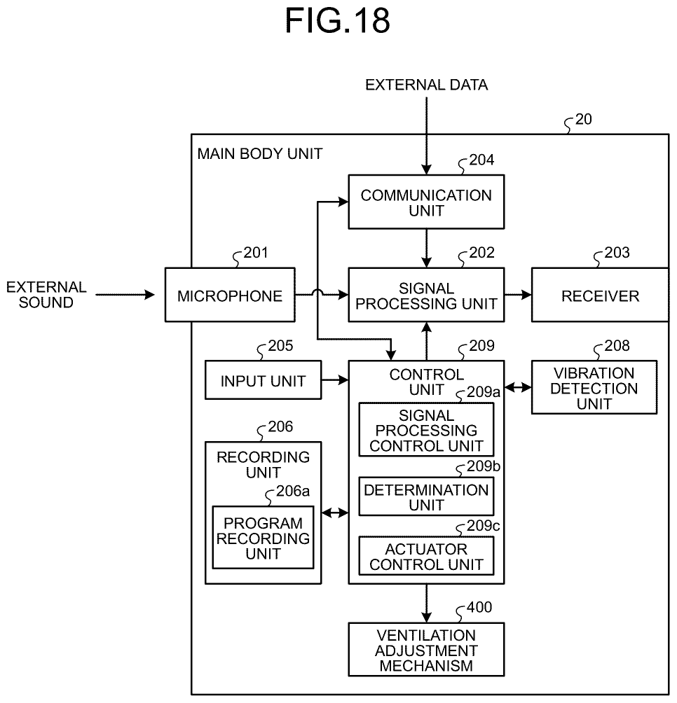

FIG. 17 is a diagram illustrating a schematic configuration of the hearing aid 2 according to the other embodiment. FIG. 18 is a block diagram illustrating a functional configuration of the hearing aid 2 according to the other embodiment.

As illustrated in FIG. 17, the hearing aid 2 according to the other embodiment includes the main body unit 20 formed in a shape insertable into an ear hole of a user and an earpiece 21a that is detachably attachable to the main body unit 20 and functions as a sleeve. Note that the hearing aid 2 may also include the taking-out thread 22 for taking out the hearing aid 2 from the ear hole of the user as in the embodiment explained above.

The main body unit 20 includes a signal processing board 20a and a ventilation adjustment mechanism 400 in addition to the microphone 201 and the receiver 203 according to the embodiment explained above. The main body unit 20 has a hole 20b. The hole 20b is formed as a passage for sound output from the receiver 203.

The earpiece 21a is formed in, for example, a substantially truncated conical tubular shape and is detachably attached to one end of the main body unit 20 to cover an end portion of the main body unit 20. The earpiece 21a is formed using, for example, silicon. The earpiece 21a functions as a replaceable sleeve.

The ventilation adjustment mechanism 400 adjusts a ventilation amount between the external ear canal of the user and the outside when the hearing aid 2 is worn on the ear of the user. The ventilation adjustment mechanism 400 includes a ventilation passage 401 functioning as a vent that ventilates the external ear canal of the user and the outside when the hearing aid 2 is worn on the ear of the user and an adjustment mechanism 402 that adjusts a ventilation amount of the ventilation passage 401.

As illustrated in FIG. 18, the main body unit 20 includes the signal processing unit 202, the communication unit 204, the input unit 205, the recording unit 206, the vibration detection unit 208, and the control unit 209 according to the embodiment explained above in addition to the microphone 201, the receiver 203, and the ventilation adjustment mechanism 400. The signal processing unit 202, the communication unit 204, the recording unit 206, the vibration detection unit 208, the control unit 209, and the like are provided, for example, on the signal processing board 20a.

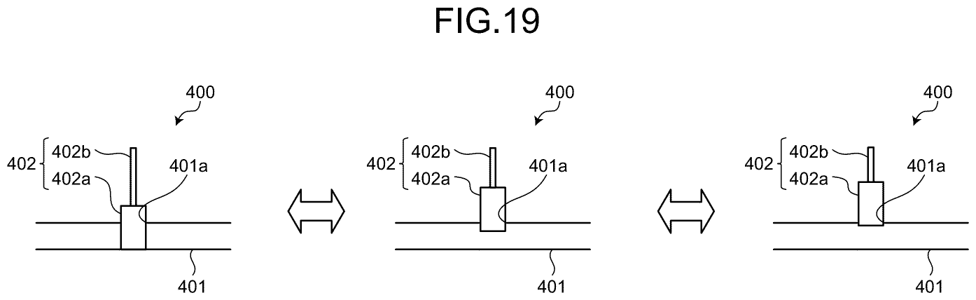

FIG. 19 is a diagram illustrating a schematic configuration of the ventilation adjustment mechanism 400 according to the other embodiment. In an example illustrated in FIG. 19, a state in which an opening amount (a ventilation amount) of the ventilation passage 401 is changed by the ventilation adjustment mechanism 400 is illustrated.

As illustrated in FIG. 19, the adjustment mechanism 402 of the ventilation adjustment mechanism 400 includes an adjustment member 402a and a soft actuator 402b.

The adjustment member 402a is provided in the ventilation passage 401 to be capable of changing the opening amount (the ventilation amount) of the ventilation passage 401. For example, the adjustment member 402a is configured to be inserted into the ventilation passage 401 from an opening 401a formed in the ventilation passage 401 and to be movable in a direction orthogonal to an extending direction of the ventilation passage 401. Accordingly, the adjustment member 402a can move in a direction of closing the ventilation passage 401 and a direction of opening the ventilation passage 401. The shape of the adjustment member 402a may be any shape if the ventilation passage 401 can be opened and closed. The opening 401a functions as an insertion port for inserting the adjustment member 402a into the ventilation passage 401.

The soft actuator 402b is connected to an end portion of the adjustment member 402a. The soft actuator 402b adjusts the ventilation amount of the ventilation passage 401 by moving the adjustment member 402a to change the opening amount of the ventilation passage 401 based on a control signal (electricity) from the actuator control unit 209c. Here, the soft actuator 402b is configured using a conductive polymer actuator capable of expanding and contracting according to a voltage or an electric current. For example, the conductive polymer actuator is configured using polyaniline, polypyrrole, or the like. In this case, when electric power (a positive voltage) is supplied from the control unit 209, the soft actuator 402b contracts (shrinks) according to an amount of electric power (the magnitude of a voltage and expands (enlarges) when the amount of electric power decreases.

The soft actuator 402b configured as explained above changes the shape thereof by expanding and contracting based on a control signal (electricity) from the actuator control unit 209c and moves the adjustment member 402a. Specifically, under the control of the actuator control unit 209c, the soft actuator 402b adjusts the ventilation amount of the ventilation passage 401 by changing the shape to the contracted state or the expanded state to move the adjustment member 402a and changing the opening amount of the ventilation passage 401.

A change amount (a deformation amount) of the shape of the soft actuator 402b changes according to the amount of electric power supplied to the soft actuator 402b. Accordingly, the opening amount (an opening degree) of the ventilation passage 401 can be changed steplessly within a range of 0 to 100%. The amount of electric power supplied to the soft actuator 402b is adjusted by the actuator control unit 209c according to the magnitude of a sound signal or the magnitude of external sound. That is, the opening amount of the ventilation passage 401 is adjusted according to the magnitude of the sound signal or the magnitude of the external sound.

As explained above, the ventilation adjustment mechanism 400 can adjust a ventilation amount between the external ear canal of the user and the outside under the control of the actuator control unit 209c when the hearing aid 2 is worn on the ear of the user.

In FIG. 19, the adjustment member 402a is provided only in one part in the ventilation passage 401. However, not only this, but a plurality of adjustment members 402a may be provided in the ventilation passage 401. In this case, a plurality of soft actuators 402b are provided according to the number of adjustment members 402a. The adjustment member 402a is provided in the ventilation passage 401. However, not only this, but the adjustment member 402a may be provided, for example, at one of both the ends of the ventilation passage 401 and can be changed as appropriate.

### <Processing of the Hearing Aid>

Subsequently, processing executed by the hearing aid 2 according to the other embodiment is explained.

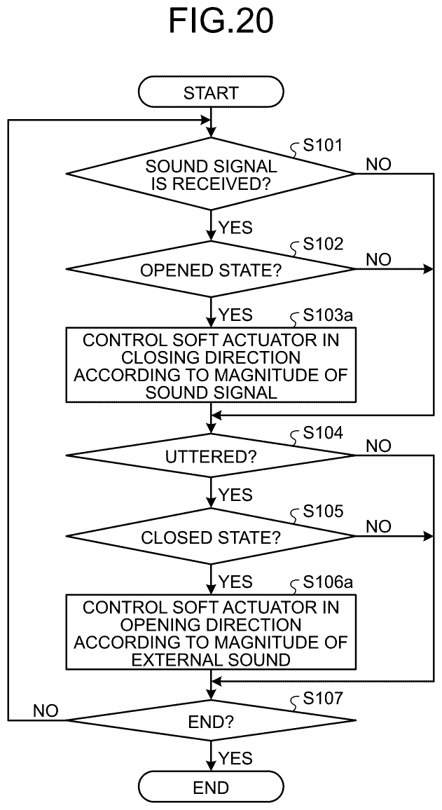

FIG. 20 is a flowchart illustrating an overview of the processing executed by the hearing aid 2 according to the other embodiment.

As illustrated in FIG. 20, steps S101, S102, S104, S105, and S107 are the same as S101, S102, S104, S105, and S107 (see FIG. 6) according to the embodiment explained above. However, steps S103a and S106a are different from the steps in the embodiment explained above. In the following explanation, steps S103a and S106a are explained.

Note that, in step S102, as in the embodiment explained above, the determination unit 209b determines whether the state of the ventilation passage 213a is the opened state. However, when determining that supply of electric power to the soft actuator 213b is stopped, the determination unit 209b determines that the state of the ventilation passage 401 is the closed state and, when determining that electric power is supplied to the soft actuator 213b, the determination unit 209b determines that the state of the ventilation passage 401 is the opened state.

In step S103a, the actuator control unit 209c controls the soft actuator 402b in a closing direction according to the magnitude (the volume) of a sound signal. The closing direction is a direction in which the soft actuator 402b extends. Specifically, the actuator control unit 209c supplies electric power (including zero) corresponding to the magnitude of the sound signal to the soft actuator 402b to thereby drive the soft actuator 402b connected to the adjustment member 402a or stop the driving and deforms the shape of the soft actuator 402b in a direction of changing from a contracted state to an expanded state (the closing direction) and moves the adjustment member 402a in a direction of closing the ventilation passage 401 to thereby reduce the opening amount (the ventilation amount) of the ventilation passage 401. Accordingly, the user wearing the hearing aid 2 can listen to sound (for example, music) corresponding to a sound signal transmitted from the communication device 4 with a sufficient sound pressure at the time of music play without much worrying about external sound. For example, the actuator control unit 209c sets electric power supplied to the soft actuator 402b such that the opening amount of the ventilation passage 401 decreases as the magnitude of the sound signal received by the communication unit 204 is smaller. After step S103a, the hearing aid 2 shifts to step S104.

Note that the signal processing control unit 209a may control an amplification factor by the signal processing unit 202 for the sound signal received by the communication unit 204. For example, the signal processing control unit 209a may set an amplification factor of a sound signal input from the communication unit 204 to be higher than an amplification factor of a sound signal input from the microphone 201.

In step S106a, the actuator control unit 209c controls the soft actuator 402b in an opening direction according to the magnitude (the volume) of external sound such as utterance of the user or another person. The opening direction is a direction in which the soft actuator 402b contracts. Specifically, the actuator control unit 209c supplies electric power corresponding to the magnitude of the external sound to the soft actuator 402b to thereby drive the soft actuator 402b connected to the adjustment member 402a and deforms the shape of the soft actuator 402b in a direction of changing from the expanded state to the contracted state (the opening direction) and moves the adjustment member 402a in a direction of opening the ventilation passage 401 to thereby increase the opening amount (the ventilation amount) of the ventilation passage 401. Accordingly, since the ventilation passage 401 of the ventilation adjustment mechanism 400 is opened and howling can be prevented, the user wearing the hearing aid 2 can listen to external sound such as utterance of the user or the other person. For example, the actuator control unit 209c sets electric power supplied to the soft actuator 402b such that the opening amount of the ventilation passage 401 increases as the magnitude of the external sound received by the microphone 201 is smaller. After step S106a, the hearing aid 2 shifts to step S107.

According to the other embodiment explained above, as in the embodiment explained above, since the actuator control unit 209c controls the shape of the soft actuator 402b, the user can comfortably use the hearing aid 2.

According to the other embodiment, as in the embodiment explained above, since the actuator control unit 209c changes the shape of the soft actuator 402b based on the reception state of the communication unit 204, the ventilation amount of the ventilation adjustment mechanism 400 can be adjusted in a state suitable for each of a sound signal of external data transmitted from the communication device 4 and an external sound signal input from the microphone 201.

According to the other embodiment, as in the embodiment explained above, since, when receiving a sound signal transmitted from the communication device 4 with the communication unit 204, the actuator control unit 209c changes the shape of the soft actuator 402b such that the ventilation amount of the ventilation adjustment mechanism 400 decreases and, when receiving input of an external sound signal from the microphone 201, the actuator control unit 209c changes the shape of the soft actuator 402b such that the ventilation amount of the ventilation adjustment mechanism 400 increases, the user can comfortably use the hearing aid 2 in a state suitable for each of a music playing function and a hearing aid function.

According to the other embodiment, as in the embodiment explained above, since, when the determination unit 209b determines that the user has uttered, the actuator control unit 209c changes the shape of the soft actuator 402b in the opening direction of changing from the closed state to the opened state, the performance of the hearing aid 2 can be switched to performance suitable for listening to utterance of the user and utterance of the other person in conversation or the like.

According to the other embodiment, since when receiving the sound signal transmitted from the communication device 4 with the communication unit 204, the actuator control unit 209c changes an amount of change in the shape of the soft actuator 402b according to the magnitude of the sound signal, the ventilation amount of the ventilation adjustment mechanism 400 can be adjusted to a state suitable for a sound signal of external data transmitted from the communication device 4.

According to the other embodiment, since the actuator control unit 209c changes the amount of change in the shape of the soft actuator 402b according to the magnitude of the external sound signal input from the microphone 201, the ventilation amount of the ventilation adjustment mechanism 400 can be adjusted to a state suitable for an external sound signal input from the microphone 201.

In the other embodiment, as in the embodiment explained above, when receiving input of an instruction signal for instructing to change the shape of the soft actuator 402b from the input unit 205, the actuator control unit 209c may change the shape of the soft actuator 402b to a shape corresponding to the instruction signal and adjust the ventilation amount of the ventilation adjustment mechanism 400. The determination unit 209b determines, based on the external sound signal input from the microphone 201, whether the user has uttered. However, not only this, but the determination unit 209b may determine, based on the vibration signal detected by the vibration detection unit 208, whether the user has uttered.

In the other embodiment, the actuator control unit 209c adjusts the electric power supplied to the soft actuator 402b to steplessly adjust the opening amount of the ventilation passage 401. However, not only this, but the actuator control unit 209c may adjust the state of the ventilation passage 401 stepwise and may switch the state of the ventilation passage 401 between an opened state (an opened state with a predetermined opening amount) and the closed state. That is, the opening amount of the ventilation passage 401 is adjusted according to the magnitude of the sound signal or the magnitude of the external sound under the control of the actuator control unit 209c. However, not only this, but the opening amount of the ventilation passage 401 may be adjusted to be a predetermined opening amount stored in the recording unit 206. For example, an appropriate opening amount is checked by pre-fitting and the appropriate opening amount is stored in the recording unit 206 as the predetermined opening amount. A movement amount of the adjustment member 402a for realizing the predetermined opening amount, that is, a change amount of the shape of the soft actuator 402b is determined from the predetermined opening amount and an amount of electric power for realizing the change amount is determined. In some case, the appropriate opening amount for the user is not 100% but is, for example, 80%. The appropriate opening amount varies among individuals. Even in such a case, it is possible to obtain an appropriate opening amount suitable for the user, that is, an appropriate ventilation amount.

In the other embodiment, moving speed of the adjustment member 402a (deformation speed of the soft actuator 402b) may be constant under the control of the actuator control unit 209c or may be changed according to the magnitude of the sound signal or the magnitude of the external sound. For example, the moving speed of the adjustment member 402a may be increased or reduced as the magnitude of the sound signal or the magnitude of the external sound increases or decreases.

### (Modification 1)

Subsequently, a modification 1 of the other embodiment explained above is explained. In the modification 1, only a configuration of the adjustment mechanism 402 included in the ventilation adjustment mechanism 400 is different. For this reason, in the following explanation, the adjustment mechanism 402 according to the modification 1 is explained. Note that the same components as the components of the hearing aid system 1 according to the other embodiment explained above are basically denoted by the same reference numerals and signs, and detailed explanation of the components is omitted.

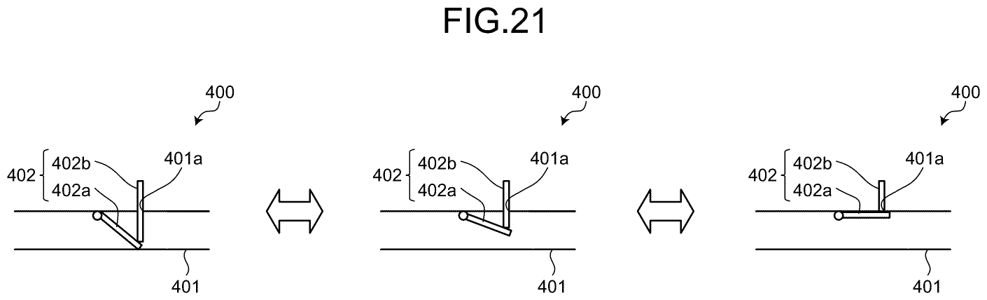

FIG. 21 is a diagram illustrating a schematic configuration of the ventilation adjustment mechanism 400 according to the modification 1 of the other embodiment. In an example illustrated in FIG. 21, a state in which an opening amount (a ventilation amount) of the ventilation passage 401 is changed by the ventilation adjustment mechanism 400 is illustrated.

As illustrated in FIG. 21, the adjustment mechanism 402 of the ventilation adjustment mechanism 400 includes the adjustment member 402a and the soft actuator 402b as in the other embodiment explained above.

As in the other embodiment explained above, the adjustment member 402a is provided in the ventilation passage 401 to be capable of changing the opening amount (the ventilation amount) of the ventilation passage 401. For example, the adjustment member 402a is configured to be rotatable centering on the end portion thereof and is provided in the ventilation passage 401. Accordingly, the adjustment member 402a can move in a direction of closing the ventilation passage 401 and a direction of opening the ventilation passage 401.

The soft actuator 402b is connected to the other end portion of the adjustment member 402a, that is, an end portion opposite to the end portion serving as the rotation center. The soft actuator 402b changes the shape thereof by expanding and contracting based on a control signal (electricity) from the actuator control unit 209c and moves the adjustment member 402a. Specifically, under the control of the actuator control unit 209c, the soft actuator 402b adjusts the ventilation amount of the ventilation passage 401 by changing the shape to the contracted state or the expanded state to move the adjustment member 402a and changing the opening amount of the ventilation passage 401. The amount of change in the shape of the soft actuator 402b changes according to the amount of electric power supplied to the soft actuator 402b.

According to the modification 1 explained above, the user can comfortably use the hearing aid 2 as in the other embodiment explained above.

In the modification 1, the soft actuator 402b is connected to the end portion opposite to the end portion serving as the rotation center of the adjustment member 402a. However, not only this, but the soft actuator 402b may be connected to the outer periphery of a rotating shaft that is the end portion serving as the rotation center.

### (Modification 2)

Subsequently, a modification 2 of the other embodiment explained above is explained. In the modification 2, only a configuration of the adjustment mechanism 402 included in the ventilation adjustment mechanism 400 is different. For this reason, in the following explanation, the adjustment mechanism 402 according to the modification 2 is explained. Note that the same components as the components of the hearing aid system 1 according to the other embodiment explained above are basically denoted by the same reference numerals and signs, and detailed explanation of the components is omitted.

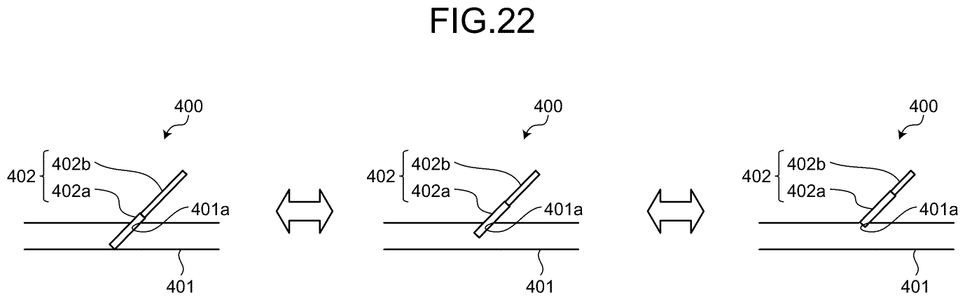

FIG. 22 is a diagram illustrating a schematic configuration of the ventilation adjustment mechanism 400 according to the modification 2 of the other embodiment. In an example illustrated in FIG. 22, a state in which an opening amount (a ventilation amount) of the ventilation passage 401 is changed by the ventilation adjustment mechanism 400 is illustrated.

As illustrated in FIG. 22, the adjustment mechanism 402 of the ventilation adjustment mechanism 400 includes the adjustment member 402a and the soft actuator 402b as in the other embodiment explained above.

As in the other embodiment explained above, the adjustment member 402a is provided in the ventilation passage 401 to be capable of changing the opening amount (the ventilation amount) of the ventilation passage 401. For example, the adjustment member 402a is configured to be inserted into the ventilation passage 401 from the opening 401a formed in the ventilation passage 401 and to be movable in a direction intersecting the extending direction of the ventilation passage 401. Accordingly, the adjustment member 402a can move in a direction of closing the ventilation passage 401 and a direction of opening the ventilation passage 401. In the example illustrated in FIG. 22, the adjustment member 402a is provided to be movable to cross the extending direction of the ventilation passage 401 at, for example, 45 degrees.

The soft actuator 402b is connected to an end portion of the adjustment member 402a. The soft actuator 402b changes the shape thereof by expanding and contracting based on a control signal (electricity) from the actuator control unit 209c and moves the adjustment member 402a. Specifically, under the control of the actuator control unit 209c, the soft actuator 402b adjusts the ventilation amount of the ventilation passage 401 by changing the shape to the contracted state or the expanded state to move the adjustment member 402a and changing the opening amount of the ventilation passage 401. The amount of change in the shape of the soft actuator 402b changes according to the amount of electric power supplied to the soft actuator 402b.

According to the modification 2 explained above, the user can comfortably use the hearing aid 2 as in the other embodiment explained above.

### (Modification 3)

Subsequently, a modification 3 of the other embodiment explained above is explained. In the modification 3, only the adjustment mechanism 402 included in the ventilation adjustment mechanism 400 is different. For this reason, in the following explanation, the adjustment mechanism 402 according to the modification 3 is explained. Note that the same components as the components of the hearing aid system 1 according to the other embodiment explained above are basically denoted by the same reference numerals and signs, and detailed explanation of the components is omitted.

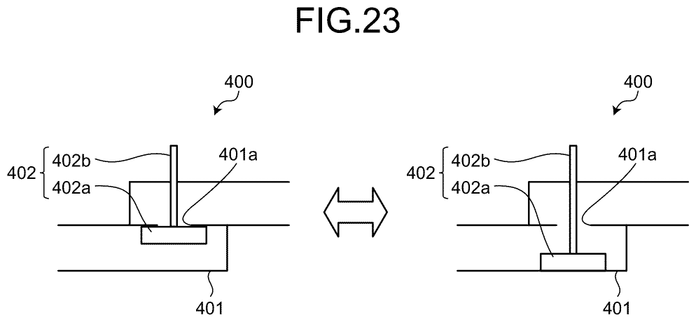

FIG. 23 is a diagram illustrating a schematic configuration of the ventilation adjustment mechanism 400 according to the modification 3 of the other embodiment. In an example illustrated in FIG. 23, a state in which an opening amount (a ventilation amount) of the ventilation passage 401 is changed by the ventilation adjustment mechanism 400 is illustrated.

As illustrated in FIG. 23, the adjustment mechanism 402 of the ventilation adjustment mechanism 400 includes the adjustment member 402a and the soft actuator 402b as in the other embodiment explained above. The ventilation passage 401 is configured to have the opening 401a on the inside thereof.

As in the other embodiment explained above, the adjustment member 402a is provided in the ventilation passage 401 to be capable of changing the opening amount (the ventilation amount) of the ventilation passage 401. For example, the adjustment member 402a is provided in the ventilation passage 401 to be capable of opening and closing the opening 401a and is configured to be movable in a direction orthogonal to the extending direction of the ventilation passage 401. Accordingly, the adjustment member 402a can move in a direction of closing the ventilation passage 401 and a direction of opening the ventilation passage 401.

The soft actuator 402b is connected to the center of the adjustment member 402a. The soft actuator 402b changes the shape thereof by expanding and contracting based on a control signal (electricity) from the actuator control unit 209c and moves the adjustment member 402a. Specifically, under the control of the actuator control unit 209c, the soft actuator 402b adjusts the ventilation amount of the ventilation passage 401 by changing the shape to the contracted state or the expanded state to move the adjustment member 402a and switching the state of the ventilation passage 401 between an opened state (a state in which an opening amount is 100%) and a closed state (a state in which the opening amount is 0%). The amount of change in the shape of the soft actuator 402b changes according to the amount of electric power supplied to the soft actuator 402b.

According to the modification 3 explained above, the user can comfortably use the hearing aid 2 as in the other embodiment explained above.

In the modification 3, the soft actuator 402b is provided to move the adjustment member 402a in the up-down direction in FIG. 23. However, not only this, but the soft actuator 402b may be provided to move the adjustment member 402a in the left-right direction in FIG. 23. In this case, the opening amount of the ventilation passage 401 can be steplessly adjusted within a range of 0 to 100%.

### 3. Other Embodiments

Various inventions can be formed by combining, as appropriate, a plurality of components disclosed in the hearing aid system according to the embodiments (the embodiment and the other embodiment) of the present disclosure explained above. For example, several components may be deleted from all the components described in the hearing aid system according to the embodiments explained above. Further, the components described in the hearing aid system according to the embodiments explained above may be combined as appropriate.

In the hearing aid system according to the embodiments of the present disclosure, the “unit” can be replaced with “means”, “circuit”, and the like. For example, the control unit can be replaced with control means or a control circuit.

The program to be executed by the hearing aid system according to the embodiments of the present disclosure is provided by being recorded in a computer-readable recording medium such as a CD-ROM, a flexible disk (FD), a CD-R, a DVD (Digital Versatile Disk), a USB medium, or a flash memory as file data in an installable format or an executable format.

The program to be executed by the hearing aid system according to the embodiments of the present disclosure may be configured to be stored on a computer connected to a network such as the Internet and provided by being downloaded via the network.

Note that, in the explanation of the flowcharts in the present specification, the context of the processing among steps is clearly indicated using the expressions such as “first”, “thereafter”, and “subsequently”. However, the order of processing necessary for carrying out the present invention is not uniquely determined by these expressions. That is, the order of the processing in the flowcharts described in the present specification can be changed within a range without inconsistency.

Although some of the embodiments of the present application are explained in detail above with reference to the drawings, these are merely exemplifications. The present disclosure can be carried out in other forms to which various modifications and improvements are applied based on the knowledge of those skilled in the art including the aspects described in the section of the present disclosure.

### 4. Appendixes

Note that the present technique can also take the following configurations.
(1)
A hearing device comprising:
a main body unit; and
an earpiece insertable into an external ear canal of a user, wherein
the main body unit or the earpiece
includes a ventilation adjustment mechanism including a soft actuator at least in a part thereof and capable of adjusting a ventilation amount between the external ear canal and outside air, and
the main body unit includes:
a microphone that collects external sound and generates an external sound signal;
a signal processing unit that amplifies the external sound signal;
a receiver that outputs sound corresponding to the external sound signal amplified by the signal processing unit; and
a control unit that changes a shape of the soft actuator.
(2)
The hearing device according to (1), further comprising
a communication unit capable of receiving an external signal from an outside, wherein
the control unit
changes the shape of the soft actuator based on a reception state of the communication unit.
(3)
The hearing device according to (2), wherein
the ventilation adjustment mechanism
further includes a ventilation passage connecting the external ear canal and the outside air,
the soft actuator
is provided to be capable of adjusting a ventilation amount of the ventilation passage, and
the control unit
changes, based on the reception state of the communication unit, the shape of the soft actuator to adjust the ventilation amount of the ventilation passage.
(4)
The hearing device according to (3), wherein
the soft actuator
is provided to be capable of opening and closing the ventilation passage, and
the control unit
changes the shape of the soft actuator to open and close the ventilation passage.
(5)
The hearing device according to (2), wherein
the ventilation adjustment mechanism further includes:
a ventilation passage connecting the external ear canal and the outside air; and
an adjustment member provided to be capable of adjusting a ventilation amount of the ventilation passage,
the soft actuator
is connected to the adjustment member, and
the control unit
changes the shape of the soft actuator based on the reception state of the communication unit to adjust the ventilation amount of the ventilation passage.
(6)
The hearing device according to any one of (2) to (5), wherein
the control unit,
when the communication unit receives a sound signal transmitted from external equipment, changes the shape of the soft actuator to reduce the ventilation amount, and on the other hand,
when the communication unit receives input of the external sound signal from the microphone, changes the shape of the soft actuator to increase the ventilation amount.
(7)
The hearing device according to any one of (2) to (6), wherein
the control unit,
when receiving input of an instruction signal for instructing a change of the shape of the soft actuator, changes the shape of the soft actuator to a shape corresponding to the instruction signal to adjust the ventilation amount.
(8)
The hearing device according to any one of (2) to (7), wherein
the control unit,
when the communication unit receives a sound signal transmitted from external equipment, changes a change amount of the shape of the soft actuator according to magnitude of the sound signal.
(9)
The hearing device according to any one of (2) to (8), wherein
the control unit
changes the shape of the soft actuator according to the external sound signal input from the microphone.
(10)
The hearing device according to (9), wherein
the control unit
changes a change amount of the shape of the soft actuator according to magnitude of the external sound signal input from the microphone.
(11)
The hearing device according to any one of (2) to (10), wherein
the control unit
determines whether the user has uttered, and
when determining that the user has uttered, changes the shape of the soft actuator to increase the ventilation amount.
(12)
The hearing device according to (11), wherein
the control unit
acquires at least one of a vibration signal obtained by detecting vibration of the main body unit and a movement signal obtained by detecting a movement of a jaw of the user, and
determines, based on at least one of the vibration signal and the movement signal, whether the user has uttered.
(13)
The hearing device according to any one of (1) to (12), wherein
the ventilation adjustment mechanism
is a vent.
(14)
The hearing device according to (1), wherein
the earpiece
further includes an earpiece main body unit formed in a cylindrical shape,
the soft actuator
is provided in the earpiece main body unit and formed in an annular shape, and
the control unit
expands and contracts the soft actuator.
(15)
The hearing device according to any one of (1) to (14), wherein
the earpiece
is detachably attachable to the main body unit.
(16)
The hearing device according to any one of (1) to (15), wherein
the soft actuator
is a conductive polymer actuator.
(17)
The hearing device according to any one of (1) to (16), wherein
the hearing device
is a hearing aid or an earphone.
(18)
An earpiece attachable to a main body unit including a microphone that collects external sound to generate an external sound signal, a signal processing unit that amplifies the external sound signal, a receiver that outputs sound corresponding to the external sound signal amplified by the signal processing unit, and a control unit, the earpiece being insertable into an external ear canal of a user, the earpiece comprising
a ventilation adjustment mechanism including a soft actuator in at least a part thereof and capable of adjusting a ventilation amount between the external ear canal and outside air under control of the control unit.
(19)
A program to be executed by a hearing device including a main body unit including a microphone that collects external sound to generate an external sound signal, a signal processing unit that amplifies the external sound signal, a receiver that outputs sound corresponding to the external sound signal amplified by the signal processing unit, and a control unit and an earpiece insertable into an external ear canal of a user, the main body unit or the earpiece including a ventilation adjustment mechanism including a soft actuator in at least a part thereof and capable of adjusting a ventilation amount between the external ear canal and outside air, the program causing
the control unit to
change a shape of the soft actuator.
(20)
A control method to be executed by a hearing device including a main body unit including a microphone that collects external sound to generate an external sound signal, a signal processing unit that amplifies the external sound signal, a receiver that outputs sound corresponding to the external sound signal amplified by the signal processing unit, and a control unit and an earpiece insertable into an external ear canal of a user, the main body unit or the earpiece including a ventilation adjustment mechanism including a soft actuator in at least a part thereof and capable of adjusting a ventilation amount between the external ear canal and outside air, the control method comprising
by the control unit,
executing changing a shape of the soft actuator.

### REFERENCE SIGNS LIST

1 HEARING AID SYSTEM
2 HEARING AID
3 CHARGING DEVICE
4 COMMUNICATION DEVICE
20 MAIN BODY UNIT
20a SIGNAL PROCESSING BOARD
20b, 211 HOLE
21, 21a, 21c EARPIECE
22 TAKING-OUT THREAD
31 HOUSING SECTION
201 MICROPHONE
202 SIGNAL PROCESSING UNIT
203 RECEIVER
204 COMMUNICATION UNIT
205 INPUT UNIT
206 RECORDING UNIT
206a PROGRAM RECORDING UNIT
207, 212 CONNECTION UNIT
208 VIBRATION DETECTION UNIT
209 CONTROL UNIT
209a SIGNAL PROCESSING CONTROL UNIT
209b DETERMINATION UNIT
209c ACTUATOR CONTROL UNIT
210 EARPIECE MAIN BODY UNIT
213, 300, 310, 400 VENTILATION ADJUSTMENT MECHANISM
213a, 401 VENTILATION PASSAGE
213b, 302, 312, 320, 402b SOFT ACTUATOR
301, 311 PLATE SECTION
301a, 311c, 401a OPENING
311a ELASTIC SECTION
311b PROTRUSION
402 ADJUSTMENT MECHANISM
402a ADJUSTMENT MEMBER
A1 AIR
U1 USER

1. A hearing device comprising:
a main body unit; and
an earpiece insertable into an external ear canal of a user, wherein
the main body unit or the earpiece
includes a ventilation adjustment mechanism including a soft actuator at least in a part thereof and capable of adjusting a ventilation amount between the external ear canal and outside air, and
the main body unit includes:
a microphone that collects external sound and generates an external sound signal;
a signal processing unit that amplifies the external sound signal;
a receiver that outputs sound corresponding to the external sound signal amplified by the signal processing unit; and
a control unit that changes a shape of the soft actuator.

2. The hearing device according to claim 1, further comprising
a communication unit capable of receiving an external signal from an outside, wherein
the control unit
changes the shape of the soft actuator based on a reception state of the communication unit.

3. The hearing device according to claim 2, wherein
the ventilation adjustment mechanism
further includes a ventilation passage connecting the external ear canal and the outside air,
the soft actuator
is provided to be capable of adjusting a ventilation amount of the ventilation passage, and
the control unit
changes, based on the reception state of the communication unit, the shape of the soft actuator to adjust the ventilation amount of the ventilation passage.

4. The hearing device according to claim 3, wherein
the soft actuator
is provided to be capable of opening and closing the ventilation passage, and
the control unit
changes the shape of the soft actuator to open and close the ventilation passage.

5. The hearing device according to claim 2, wherein
the ventilation adjustment mechanism further includes:
a ventilation passage connecting the external ear canal and the outside air; and
an adjustment member provided to be capable of adjusting a ventilation amount of the ventilation passage,
the soft actuator
is connected to the adjustment member, and
the control unit
changes the shape of the soft actuator based on the reception state of the communication unit to adjust the ventilation amount of the ventilation passage.

6. The hearing device according to claim 2, wherein
the control unit,
when the communication unit receives a sound signal transmitted from external equipment, changes the shape of the soft actuator to reduce the ventilation amount, and on the other hand,
when the communication unit receives input of the external sound signal from the microphone, changes the shape of the soft actuator to increase the ventilation amount.

7. The hearing device according to claim 2, wherein
the control unit,
when receiving input of an instruction signal for instructing a change of the shape of the soft actuator, changes the shape of the soft actuator to a shape corresponding to the instruction signal to adjust the ventilation amount.

8. The hearing device according to claim 2, wherein
the control unit,
when the communication unit receives a sound signal transmitted from external equipment, changes a change amount of the shape of the soft actuator according to magnitude of the sound signal.

9. The hearing device according to claim 2, wherein
the control unit
changes the shape of the soft actuator according to the external sound signal input from the microphone.

10. The hearing device according to claim 9, wherein
the control unit
changes a change amount of the shape of the soft actuator according to magnitude of the external sound signal input from the microphone.

11. The hearing device according to claim 2, wherein
the control unit
determines whether the user has uttered, and
when determining that the user has uttered, changes the shape of the soft actuator to increase the ventilation amount.

12. The hearing device according to claim 11, wherein
the control unit
acquires at least one of a vibration signal obtained by detecting vibration of the main body unit and a movement signal obtained by detecting a movement of a jaw of the user, and
determines, based on at least one of the vibration signal and the movement signal, whether the user has uttered.

13. The hearing device according to claim 1, wherein
the ventilation adjustment mechanism
is a vent.

14. The hearing device according to claim 1, wherein
the earpiece
further includes an earpiece main body unit formed in a cylindrical shape,
the soft actuator
is provided in the earpiece main body unit and formed in an annular shape, and
the control unit
expands and contracts the soft actuator.

15. The hearing device according to claim 1, wherein
the earpiece
is detachably attachable to the main body unit.

16. The hearing device according to claim 1, wherein
the soft actuator
is a conductive polymer actuator.

17. The hearing device according to claim 1, wherein
the hearing device
is a hearing aid or an earphone.

18. An earpiece attachable to a main body unit including a microphone that collects external sound to generate an external sound signal, a signal processing unit that amplifies the external sound signal, a receiver that outputs sound corresponding to the external sound signal amplified by the signal processing unit, and a control unit, the earpiece being insertable into an external ear canal of a user, the earpiece comprising
a ventilation adjustment mechanism including a soft actuator in at least a part thereof and capable of adjusting a ventilation amount between the external ear canal and outside air under control of the control unit.

19. A program to be executed by a hearing device including a main body unit including a microphone that collects external sound to generate an external sound signal, a signal processing unit that amplifies the external sound signal, a receiver that outputs sound corresponding to the external sound signal amplified by the signal processing unit, and a control unit and an earpiece insertable into an external ear canal of a user, the main body unit or the earpiece including a ventilation adjustment mechanism including a soft actuator in at least a part thereof and capable of adjusting a ventilation amount between the external ear canal and outside air, the program causing
the control unit to
change a shape of the soft actuator.

20. A control method to be executed by a hearing device including a main body unit including a microphone that collects external sound to generate an external sound signal, a signal processing unit that amplifies the external sound signal, a receiver that outputs sound corresponding to the external sound signal amplified by the signal processing unit, and a control unit and an earpiece insertable into an external ear canal of a user, the main body unit or the earpiece including a ventilation adjustment mechanism including a soft actuator in at least a part thereof and capable of adjusting a ventilation amount between the external ear canal and outside air, the control method comprising
by the control unit,
executing changing a shape of the soft actuator.
